(19) United States
(12) Patent Application Publication
(10) Pub. No.: US 2019/0202350 A1
(43) Pub. Date: Jul. 4, 2019

(54) INTERIOR VEHICLE LIGHTING SYSTEMS WITH ORGANIC LIGHT EMITTING DIODES

(71) Applicant: GM Global Technology Operations LLC, Detroit, MI (US)

(72) Inventors: Xue TIAN, Shanghai (CN); Nicolina M. CASANOVA, Macomb Township, MI (US)

(73) Assignee: GM Global Technology Operations LLC, Detroit, MI (US)

(21) Appl. No.: 15/860,127

(22) Filed: Jan. 2, 2018

(51) Int. Cl. B60Q 3/217; B60Q 3/54; B60Q 3/51

(52) U.S. Cl. CPC B60Q 3/217; B60Q 2500/10; B60Q 3/51; B60Q 3/54

(57) ABSTRACT

A lighting system for an interior compartment of a vehicle includes an organic light emitting diode (OLED) configured to illuminate the interior compartment of the vehicle and a substrate configured to retain the OLED. The substrate is a trim component located in the interior compartment of the vehicle. A direct lighting system for an interior compartment of a vehicle includes an OLED and a housing. The housing includes an opening configured to allow light emitted from the OLED to illuminate the interior compartment of the vehicle. The housing may include a plurality of retaining tabs configured to retain the OLED. Alternatively, the housing may be disposed below the OLED and the direct lighting system may include a backing plate disposed above the OLED and a plurality of coupling members configured to affix the backing plate to the housing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the illumination of an interior compartment of a vehicle using organic light emitting diodes (OLEDs).

Some vehicles include interior lighting systems that use incandescent or light emitting diodes (LEDs) to light an interior compartment of the vehicle. These interior lighting systems may include ambient lighting systems that produce diffuse light in the compartment. The interior lighting systems may also include direct lighting systems that produce directed or focused light in the compartment.

### SUMMARY

A lighting system for an interior compartment of a vehicle includes an organic light emitting diode (OLED) configured to illuminate the interior compartment of the vehicle and a substrate configured to retain the OLED. The substrate is a trim component located in the interior compartment of the vehicle.

In some configurations, the trim component is a mid-pad backing outlet plate of an interior door of the vehicle.

In some configurations, the substrate includes a first surface, a plurality of retaining arms, and a raised body. The first surface defines a first plane. Each retaining arm of the plurality of retaining arms extends above the first plane and includes a first body that is perpendicular to the first plane and a second body that is (i) disposed above the first plane and (ii) parallel to the first plane.

In some configurations, the plurality of retaining arms includes a first pair of retaining arms and a second pair of retaining arms. The raised body is disposed between the first pair of retaining arms and the second pair of retaining arms.

In some configurations, a second surface of the raised body defines a second plane that is parallel to the first plane. The OLED is disposed (i) above the second plane and (ii) below the second body of each retaining arm of the plurality of retaining arms.

In some configurations, the OLED is a soft OLED and a first distance between the first plane and the second plane is 0-3 mm.

In some configurations, the first pair of retaining arms includes a first retaining arm and the second pair of retaining arms includes a second retaining arm. The first retaining arm includes a third surface disposed toward the second retaining arm. The third surface defines a third plane. The second retaining arm includes a fourth surface disposed toward the first retaining arm. The fourth surface defines a fourth plane that is parallel to the third plane. A second distance between third plane and the fourth plane is 1-200 mm.

In some configurations, the first retaining arm includes a fifth surface (i) opposite to the third surface and (ii) parallel to the third surface. The fifth surface defines a fifth plane and a third distance between the third plane and the fifth plane is 1-30 mm.

In some configurations, the first retaining arm extends 0.5-10.0 mm above the first surface of the substrate.

A direct lighting system for an interior compartment of a vehicle includes an organic light emitting diode (OLED), a housing disposed below the OLED, a backing plate disposed above the OLED, and a plurality of coupling members configured to affix the backing plate to the housing. The housing includes an opening configured to allow light emitted from the OLED to illuminate the interior compartment of the vehicle.

In some configurations, the plurality of coupling members includes a first screw, a second screw, a third screw, and a fourth screw.

In some configurations, the OLED is a hard OLED.

In some configurations, the backing plate includes a plurality of cylindrical spacing members. Each cylindrical spacing member of the plurality of cylindrical spacing members extends toward the OLED.

In some configurations, the backing plate includes a first surface disposed toward the OLED. The OLED includes a second surface (i) disposed toward the first surface and (ii) parallel to the first surface. The first surface defines a first plane and the second surface defines a second plane. A first distance between the first plane and the second plane is 0.1-5.0 mm.

In some configurations, the housing is a dome light housing.

A direct lighting system for an interior compartment of a vehicle includes an organic light emitting diode (OLED) and a housing configured to retain the OLED. The housing includes a first surface that defines a first plane and a second surface (i) parallel to the first surface, (ii) disposed below the first plane, and (iii) configured to support the OLED. The housing further includes a plurality of retaining tabs configured to retain the OLED and an opening configured to allow light emitted from the OLED to illuminate the interior compartment of the vehicle.

In some configurations, the plurality of retaining tabs includes a first pair of retaining tabs and a second pair of retaining tabs. The first pair of retaining tabs includes a first retaining tab and the second pair of retaining tabs includes a second retaining tab. The first retaining tab includes a third surface disposed toward the second retaining tab. The second retaining tab includes a fourth surface (i) parallel to the third surface and (ii) disposed toward the first retaining tab. The third surface defines a second plane and the fourth surface defines a third plane. A first distance between the second plane and the third plane is 1-200 mm.

In some configurations, the first retaining tab includes a fifth surface (i) opposite to the third surface and (ii) parallel to the third surface. The fifth surface defines a fourth plane. A second distance between the fourth plane and the second plane is 1-30 mm.

In some configurations, the first retaining tab includes a first portion that includes a top. A fifth plane (i) intersects the top of the first portion and (ii) is parallel to the first plane. A third distance between the first plane and the fifth plane is 2-6 mm.

In some configurations, the second pair of retaining tabs includes a third retaining tab. The first retaining tab includes a second portion and the second portion extends from the first portion toward the third retaining tab. The second portion includes a sixth surface configured to secure the OLED to the second surface.

In some configurations, the OLED is a hard OLED.

In some configurations, the housing is a dome light housing.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a perspective view of an ambient lighting system according to the present disclosure;

FIG. 1B is a top view of the ambient lighting system of FIG. 1A with the OLED omitted;

FIG. 1C is a first cross-sectional view of the ambient lighting system of FIG. 1A;

FIG. 1D is second cross-sectional view of the ambient lighting system of FIG. 1A with the OLED omitted and taken at line 1D-1D of FIG. 1C;

FIG. 2 is a perspective view of interior trim components of a vehicle door;

FIG. 3A is a perspective view of a first direct lighting system according to the present disclosure;

FIG. 3B is a cross-sectional view of the first direct lighting system of FIG. 3A;

FIG. 4A is a perspective view of a second direct lighting system according to the present disclosure; and

FIG. 4B is a cross-sectional view of the second direct lighting system of FIG. 4A.

In the drawings, reference numbers may be reused to identify similar and/or identical elements.

### DETAILED DESCRIPTION

As discussed above, some vehicles include interior lighting systems to illuminate an interior compartment of the vehicle. The interior lighting systems may include ambient lighting systems that produce diffuse light and direct lighting systems that produce directed, focused light. The interior lighting systems may use incandescent bulbs or light emitting diodes (LEDs) as lighting sources. The use of incandescent bulbs and LEDs in interior lighting systems requires the use of additional components. For example, ambient lighting systems that use an incandescent bulb or an LED as a light source require light tubes to disperse the generated light. Additionally, direct lighting systems that use an incandescent bulb or an LED as the light source may require a separate collimator or lens to focus the generated light. These additional components increase both the complexity and overall weight of the lighting systems.

The present disclosure relates to using organic light emitting diodes (OLEDs) as the light source in interior lighting systems. The use of OLEDS reduces the complexity and weight of the lighting system. There are two main types of OLEDs: soft OLEDs and hard OLEDs. A soft OLED is a thin flexible strip comprised of a series of organic thin films between two conductors. A soft OLED emits bright, uniform light across the entire surface of the strip. Thus, ambient lighting systems that use soft OLEDs do not require additional components to disperse the light generated by the soft OLED. A hard OLED includes a hard substrate and a transparent layer or seal. Hard OLEDs emit a uniform light through the transparent layer. Thus, direct lighting systems that use hard OLEDs do not require additional components to focus the generated light, e.g. a collimator or lens. The lack of additional components allows lighting systems that use OLEDs to be thinner and more compact than lighting systems that use incandescent or LED light sources. Lighting systems that use OLEDs may also use less energy and have a longer operating life than interior lighting systems that use incandescent bulbs or LEDs as lighting sources. Thus, the use of OLEDs improves the overall operation of an interior lighting system in a vehicle.

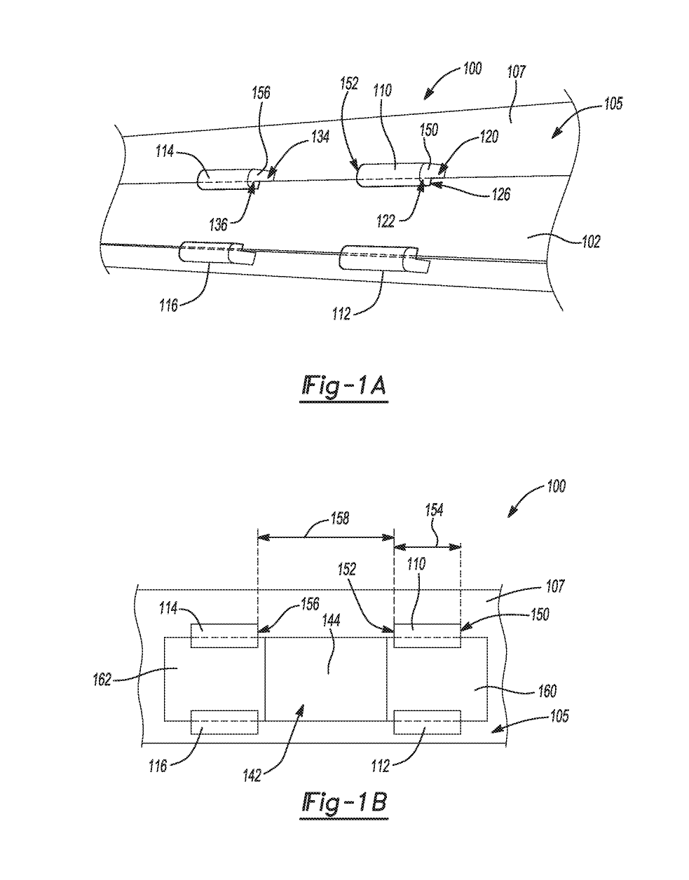

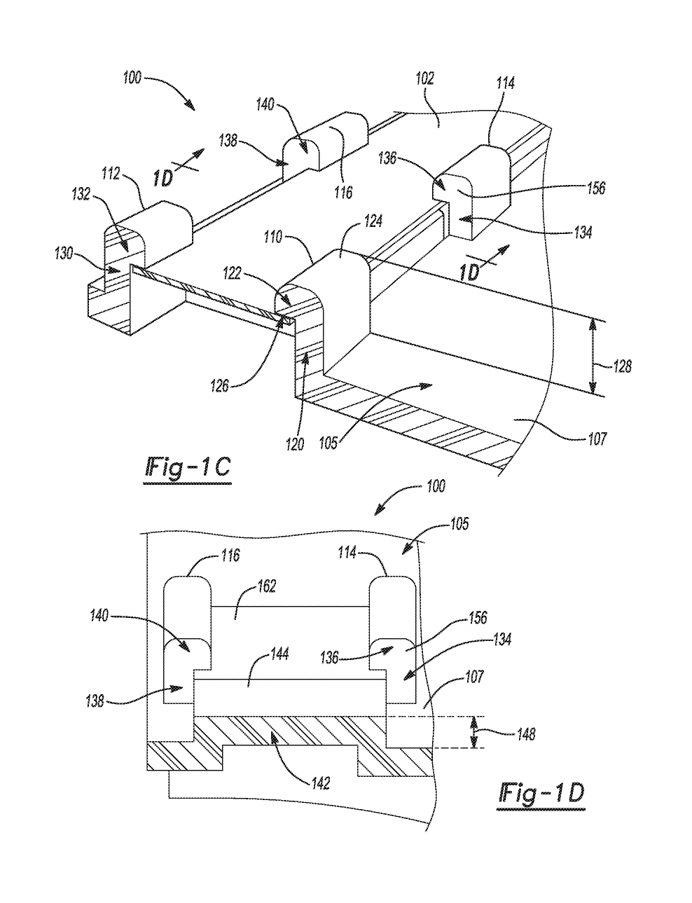

Referring to FIGS. 1A-1D, an ambient lighting system 100 includes a soft OLED 102 and a substrate 105. The soft OLED 102 is configured to illuminate an interior compartment of a vehicle. A first top surface 107 of the substrate 105 defines a first plane. The substrate 105 includes a plurality of retaining arms configured to secure the soft OLED 102. The plurality of retaining arms includes a first pair of retaining arms that includes a first retaining arm 110 and a second retaining arm 112. The plurality of retaining arms also includes a second pair of retaining arms that includes a third retaining arm 114 and a fourth retaining arm 116. Although the substrate 105 is shown as including four retaining arms, the substrate 105 may include any number of retaining arms to secure the soft OLED 102.

The first retaining arm 110 includes a first body 120 and a second body 122. The first body 120 of the first retaining arm 110 projects from the first top surface 107 of the substrate 105. The first body 120 of the first retaining arm 110 is perpendicular to the first plane defined by the first top surface 107 of the substrate 105. The second body 122 of the first retaining arm 110 extends towards the second retaining arm 112. The second body 122 includes a second top surface 124 and a first bottom surface 126. The first bottom surface 126 is disposed toward the soft OLED 102. The first bottom surface 126 is parallel to and disposed above the first plane defined by the first top surface 107 of the substrate 105. The first bottom surface 126 is configured to retain the soft OLED 102. The second top surface 124 is disposed away from the soft OLED 102. The second top surface 124 defines a second plane. A first distance 128 is defined as the distance between the first plane and the second plane. In various implementations, the first distance 128 is 0.5-10 mm.

The second retaining arm 112 includes a third body 130 and a fourth body 132. The third body 130 of the second retaining arm 112 projects from the first top surface 107 of the substrate 105. The third body 130 of the second retaining arm 112 is perpendicular to the first plane defined by the first top surface 107 of the substrate 105. The fourth body 132 of the second retaining arm 112 extends towards the first retaining arm 110. The fourth body 132 of the second retaining arm 112 is parallel to and disposed above the first plane defined by the first top surface 107 of the substrate 105. The second body 122 of the first retaining arm 110 and the fourth body 132 of the second retaining arm 112 are disposed above the soft OLED 102.

The third retaining arm 114 includes a fifth body 134 and a sixth body 136. The fifth body 134 and the sixth body 136 of the third retaining arm 114 are identical to the first body 120 and the second body 122 of the first retaining arm 110, respectively. Similarly, the fourth retaining arm 116 includes a seventh body 138 and an eighth body 140 that are identical to the third body 130 and the fourth body 132 of the second retaining arm 112, respectively.

FIG. 1D shows a cross-sectional view of the ambient lighting system 100 taken at line 1D-1D of FIG. 1C. In FIG. 1D, the soft OLED 102 has been omitted to show the structure of the substrate 105 that is below the soft OLED 102. The substrate 105 includes a raised body 142 disposed between the first pair of retaining arms (110 and 112) and the second pair of retaining arms (114 and 116). The raised body 142 includes a third top surface 144. The third top surface 144 of the raised member defines a third plane. The third plane is (i) parallel to the first plane and (ii) disposed below the soft OLED 102. A second distance 148 is defined as the distance between the first plane and the third plane. The raised body 142 elevates the soft OLED 102 above the first top surface 107 of the substrate 105 to aid in the insertion and removal of the soft OLED 102 from the ambient lighting system 100. Specifically, the raised body 142 aides in the installation and removal of the soft OLED 102 from the plurality of retaining arms. In various implementations, the second distance 148 is any distance up to and including 3 mm. In other implementations, the second distance 148 may be any suitable distance that aids in the insertion and removal of the soft OLED 102 from the ambient lighting system 100.

The first retaining arm 110 includes a first surface 150 and a second surface 152 that is opposite the first surface 150. In various implementations, the first surface 150 is parallel to the second surface 152, as shown. The first surface 150 defines a fourth plane and the second surface 152 defines a fifth plane. A third distance 154 is defined as the distance between the fourth plane and the fifth plane. In an example implementation, the third distance 154 is 1-30 mm. The third retaining arm 114 includes a third surface 156 that is disposed toward the second surface 152 of the first retaining arm 110. The third surface 156 defines a sixth plane. A fourth distance 158 is defined as the distance between the sixth plane and the fifth plane. In various implementations, the fourth distance 158 is 1-200 mm.

The substrate 105 includes a first aperture 160 and a second aperture 162. In an example implementation, the first aperture 160 and the second aperture 162 have a rectangular shape, as shown. In other implementations, the first aperture 160 and the second aperture 162 may have other shapes, such as a circle or oval.

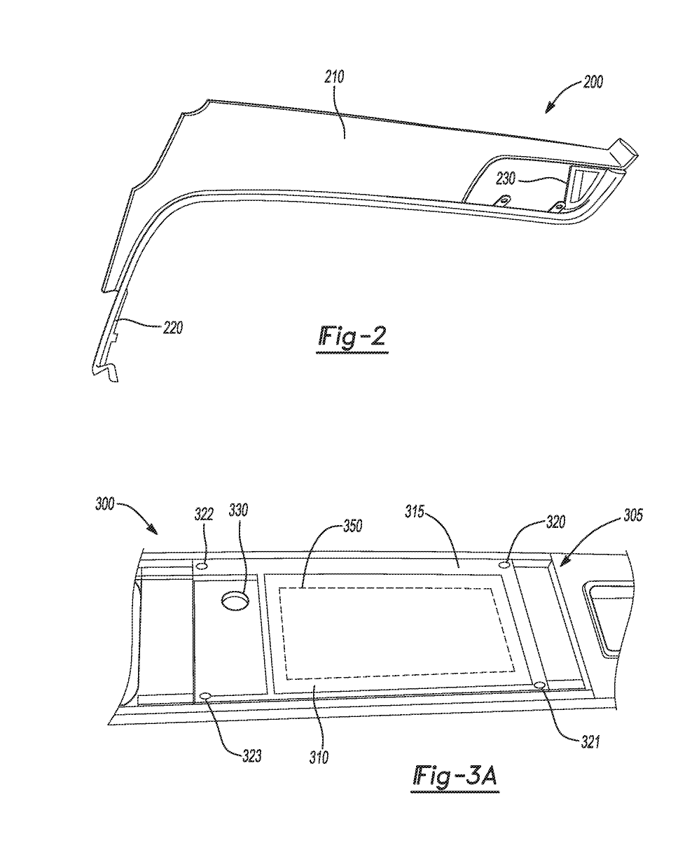

Referring to FIG. 2, interior trim components 200 of a vehicle door include a mid-pad 210, a mid-pad bright trim 220, and a mid-pad outlet back plate 230. In an example implementation, the mid-pad outlet back plate 230 is the substrate 105 of the ambient lighting system 100. In other implementations, the substrate 105 may be any suitable component located in the interior compartment of the vehicle.

Referring to FIGS. 3A-3B, a first direct lighting system 300 includes a first housing 305, a first hard OLED 310, and a backing plate 315. The first hard OLED 310 is disposed between the first housing 305 and the backing plate 315. The first housing 305 includes a fourth surface 317 and a fifth surface 318. The fourth and fifth surfaces 317, 318 are disposed toward the exterior of a vehicle. The fifth surface 318 is configured to support the first hard OLED 310. The backing plate 315 is fixed to the first housing 305 by a plurality of coupling members. The plurality of coupling members includes a first coupling member 320, a second coupling member 321, a third coupling member 322, and a fourth coupling member 323. In various implementations, the coupling members 320, 321, 322, and 323 are screws. In other implementations, the coupling members 320, 321, 322, and 323 may be any means capable of fixing the backing plate 315 to the first housing 305. In various implementations, the backing plate 315 includes a third aperture 330. Although the third aperture 330 is shown as being circular in shape, the third aperture 330 may have other shapes, such as either a square or a rectangle with rounded corners.

The first housing 305 includes a first opening 350 that is disposed below the first hard OLED 310. The first opening 350 is smaller than the first hard OLED 310. The first opening 350 allows light generated by the first hard OLED 310 to enter into an interior compartment of the vehicle.

FIG. 3B shows a cross-sectional view of the first direct lighting system 300. The backing plate 315 includes a fourth top surface 360, a second bottom surface 361, and a plurality of cylindrical spacing members. The fourth top surface 360 is disposed toward an exterior of the vehicle and the second bottom surface 361 is disposed toward the interior of the vehicle. The fourth top surface 360 is parallel to the second bottom surface 361. The plurality of cylindrical spacing members includes a first cylindrical spacing member 365. The first cylindrical spacing member 365 projects from the second bottom surface 361 toward the first hard OLED 310 and is configured to create a gap between the second bottom surface 361 and the first hard OLED 310. A sixth distance 370 is defined as the distance between the second bottom surface 361 and the first hard OLED 310. In various implementations, the sixth distance 370 is 0.1-5 mm. The fourth top surface 360 defines a seventh plane and the second bottom surface 361 defines an eighth plane. A fifth distance 368 is defined as the distance between the seventh plane and the eighth plane. In various implementations, the fifth distance 368 is 0.1-5.0 mm.

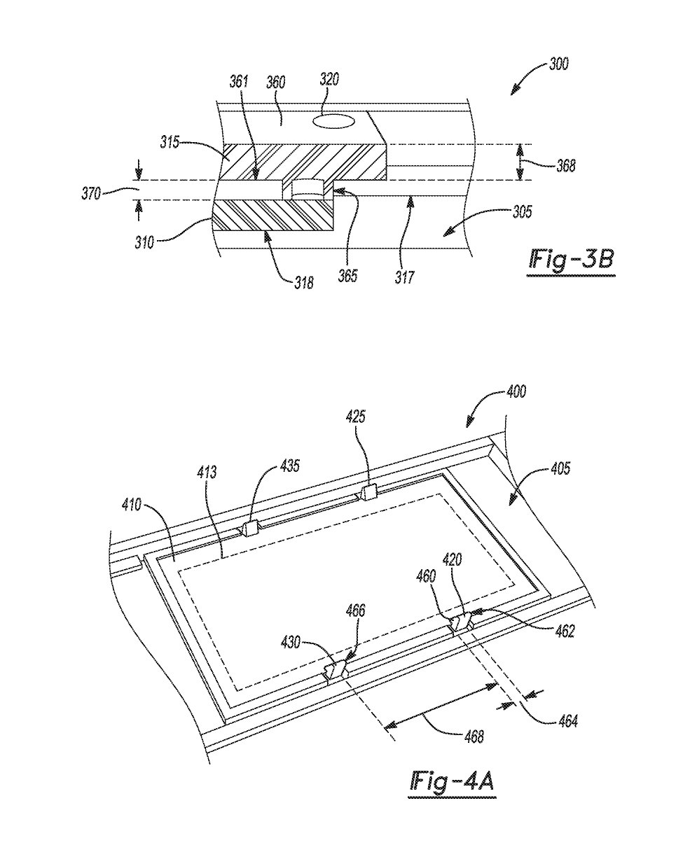

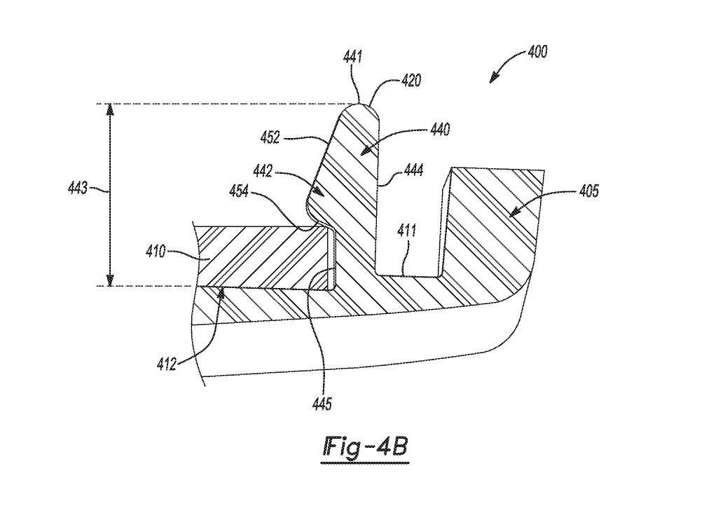

Referring to FIGS. 4A-4B, a second direct lighting system 400 includes a second housing 405 and a second hard OLED 410. The second housing 405 includes a sixth surface 411 and a seventh surface 412. The sixth and seventh surfaces 411, 412 are disposed toward the exterior of a vehicle. The seventh surface 412 is configured to support the second hard OLED 410. The second housing 405 includes a second opening 413 that is disposed below the second hard OLED 410. The second opening 413 is smaller than the second hard OLED 410. The second opening 413 allows light generated by the second hard OLED 410 to enter an interior compartment of the vehicle.

The second housing 405 further includes a plurality of retaining tabs. The plurality of retaining tabs includes a first pair of retaining tabs and a second pair of retaining tabs. The first pair of retaining tabs includes a first retaining tab 420 and a second retaining tab 425. The second pair of retaining tabs includes a third retaining tab 430 and a fourth retaining tab 435.

FIG. 4B shows a cross sectional view of the second direct lighting system of FIG. 4A. The first retaining tab 420 includes a first portion 440 and a second portion 442. The first portion 440 extends from the second housing 405 towards the exterior of the vehicle. The first portion 440 includes a top 441. A ninth plane is defined as the plane that (i) intersects the top 441 of the first portion 440 and (ii) is parallel to the seventh surface 412. A seventh distance 443 is defined as the distance between the ninth plane and the seventh surface 412 of the second housing 405. In various implementations, the seventh distance 443 is 2-6 mm. The first portion 440 includes an outside surface 444 disposed away from the second hard OLED 410 and an inside surface 445 disposed toward the second hard OLED 410. The outside surface 444 is parallel to the inside surface 445.

The second portion 442 extends from the first portion 440 towards the second retaining tab 425. The second portion 442 includes an eighth surface 452 and a ninth surface 454. The eighth surface 452 is configured to, upon insertion of the second hard OLED 410 into the second housing 405, displace the first retaining tab 420 in a direction away from the second hard OLED 410. The ninth surface 454 is configured to fix the second hard OLED 410 to the seventh surface 412 of the second housing 405.

Referring to FIG. 4A, the first retaining tab 420 also includes a tenth surface 460 and an eleventh surface 462 that is opposite the tenth surface 460. The tenth surface 460 is disposed towards the third retaining tab 430. The tenth surface 460 is (i) parallel to the eleventh surface 462. The tenth surface 460 defines a tenth plane and the eleventh surface 462 defines an eleventh plane. An eighth distance 464 is defined as the distance between the tenth plane and the eleventh plane. In various implementations, the eighth distance 464 is 1-30 mm.

The third retaining tab 430 includes a twelfth surface 466 disposed toward the first retaining tab 420. The twelfth surface 466 is (i) parallel to the eleventh surface 460 and (ii) defines a twelfth plane. A ninth distance 468 is defined as the distance between the twelfth plane and the tenth plane. In various implementations, the ninth distance 468 is 1-200 mm.

In various implementations, the first housing 305 and the second housing 405 are an overhead dome light housing located in the interior compartment of the vehicle. In other implementations, the first housing 305 and the second housing 405 may be another suitable lighting housing in the interior compartment of the vehicle.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A lighting system for an interior compartment of a vehicle comprising:
an organic light emitting diode (OLED) configured to illuminate the interior compartment of the vehicle; and
a substrate configured to retain the OLED, wherein the substrate is a trim component located in the interior compartment of the vehicle.

2. The lighting system of claim 1, wherein the trim component is a mid-pad backing outlet plate of an interior door of the vehicle.

3. The lighting system of claim 1, wherein:
the substrate includes:
a first surface,
a plurality of retaining arms, and
a raised body,
the first surface defines a first plane,
each retaining arm of the plurality of retaining arms:
extends above the first plane, and
includes a first body that is perpendicular to the first plane and a second body that is (i) disposed above the first plane and (ii) parallel to the first plane,
the plurality of retaining arms includes a first pair of retaining arms and a second pair of retaining arms,
the raised body is disposed between the first pair of retaining arms and the second pair of retaining arms,
a second surface of the raised body defines a second plane that is parallel to the first plane, and
the OLED is disposed (i) above the second plane and (ii) below the second body of each retaining arm of the plurality of retaining arms.

4. The lighting system of claim 3, wherein:
the OLED is a soft OLED, and
a first distance between the first plane and the second plane is 0-3 mm.

5. The lighting system of claim 3, wherein:
the first pair of retaining arms includes a first retaining arm,
the second pair of retaining arms includes a second retaining arm,
the first retaining arm includes a third surface disposed toward the second retaining arm,
the third surface defines a third plane,
the second retaining arm includes a fourth surface disposed toward the first retaining arm,
the fourth surface defines a fourth plane that is parallel to the third plane, and
a second distance between third plane and the fourth plane is 1-200 mm.

6. The lighting system of claim 5, wherein:
the first retaining arm includes a fifth surface (i) opposite to the third surface and (ii) parallel to the third surface,
the fifth surface defines a fifth plane, and
a third distance between the third plane and the fifth plane is 1-30 mm.

7. The lighting system of claim 5, wherein the first retaining arm extends 0.5-10.0 mm above the first surface of the substrate.

8. A direct lighting system for an interior compartment of a vehicle comprising:
an organic light emitting diode (OLED);
a housing disposed below the OLED;
a backing plate disposed above the OLED; and
a plurality of coupling members configured to affix the backing plate to the housing,
wherein the housing includes an opening configured to allow light emitted from the OLED to illuminate the interior compartment of the vehicle.

9. The direct lighting system of claim 8, wherein the plurality of coupling members includes a first screw, a second screw, a third screw, and a fourth screw.

10. The direct lighting system of claim 8, wherein the OLED is a hard OLED.

11. The direct lighting system of claim 8, wherein:
the backing plate includes a plurality of cylindrical spacing members, and
each cylindrical spacing member of the plurality of cylindrical spacing members extends toward the OLED.

12. The direct lighting system of claim 11, wherein:
the backing plate includes a first surface disposed toward the OLED,
the OLED includes a second surface (i) disposed toward the first surface and (ii) parallel to the first surface,
the first surface defines a first plane and the second surface defines a second plane, and
a first distance between the first plane and the second plane is 0.1-5.0 mm.

13. The direct lighting system of claim 8, wherein the housing is a dome light housing.

14. A direct lighting system for an interior compartment of a vehicle comprising:
an organic light emitting diode (OLED); and
a housing configured to retain the OLED,
wherein:
the housing includes:
a first surface that defines a first plane,
a second surface (i) parallel to the first surface, (ii) disposed below the first plane, and (iii) configured to support the OLED,
a plurality of retaining tabs configured to retain the OLED, and
an opening configured to allow light emitted from the OLED to illuminate the interior compartment of the vehicle.

15. The direct lighting system of claim 14, wherein:
the plurality of retaining tabs includes a first pair of retaining tabs and a second pair of retaining tabs,
the first pair of retaining tabs includes a first retaining tab,
the second pair of retaining tabs includes a second retaining tab,
the first retaining tab includes a third surface disposed toward the second retaining tab,
the second retaining tab includes a fourth surface (i) parallel to the third surface and (ii) disposed toward the first retaining tab,
the third surface defines a second plane and the fourth surface defines a third plane, and
a first distance between the second plane and the third plane is 1-200 mm.

16. The direct lighting system of claim 15, wherein:
the first retaining tab includes a fifth surface (i) opposite to the third surface and (ii) parallel to the third surface,
the fifth surface defines a fourth plane, and
a second distance between the fourth plane and the second plane is 1-30 mm.

17. The direct lighting system of claim 15, wherein:
the first retaining tab includes a first portion that includes a top,
a fifth plane (i) intersects the top of the first portion and (ii) is parallel to the first plane, and
a third distance between the first plane and the fifth plane is 2-6 mm.

18. The direct lighting system of claim 17, wherein:
the second pair of retaining tabs includes a third retaining tab,
the first retaining tab includes a second portion,
the second portion extends from the first portion toward the third retaining tab,
the second portion includes a sixth surface configured to secure the OLED to the second surface.

19. The direct lighting system of claim 14, wherein the OLED is a hard OLED.

20. The direct lighting system of claim 14, wherein the housing is a dome light housing.
